(19) United States
(12) Patent Application Publication
(10) Pub. No.: US 2006/0040177 A1
(43) Pub. Date: Feb. 23, 2006

(54) Electrochemical cell

(76) Inventors: Hideharu Onodera, Miyagi (JP); Tomohiko Kida, Miyagi (JP); Shunji Watanabe, Miyagi (JP); Kensuke Tahara, Miyagi (JP)

Correspondence Address: BRUCE L. ADAMS, ESQ., SUITE 1231, 17 BATTERY PLACE, NEW YORK, NY, 10004, US

(21) Appl. No.: 11/199,112

(22) Filed: Aug. 8, 2005

(30) Foreign Application Priority Data
Aug. 20, 2004 (JP) 2004-241055

(51) Int. Cl. H01M 2/08; H01M 10/04

(52) U.S. Cl. 429/174; 429/185; 29/623.4

(57) ABSTRACT

In an electrochemical cell in which a container is bonded to a cap, observation of liquid leakage has been needed in directions from four sides of the container, therefore much time and high cost have been required. The outer circumference of the cap is made to be smaller than that of the container, whereby surfaces for observing liquid leakage can be made to be only one surface in a direction from an upside of the cap, consequently an electrochemical cell can be provided at low cost.

### BACKGROUND OF THE INVENTION

1. Field of the Invention

The present invention relates to an electrochemical cell such as nonaqueous-electrolyte secondary battery or electric double layer capacitor.

2. Description of the Related Art

The electrochemical cell such as nonaqueous-electrolyte secondary battery or electric double layer capacitor, having features of high energy density, lightweight, and small size, has been used for a backup power source for a clock function of mobile devices or a backup power source for a semiconductor memory. The mobile devices are needed to have smaller size and lighter weight, and have improved performance, and further high density package of the electrochemical cell is required.

When the electrochemical cell is mounted on a circuit board, reflow soldering is generally used. The reflow soldering is a soldering method by applying a soldering cream on an area to be soldered in the circuit board, and then placing the electrochemical cell thereon, and then allowing the cell to pass through an inside of a furnace at a high temperature of 200° C. to 260° C. together with the circuit board. The electrochemical cell is required to have high heat resistance in order to resist the reflow soldering.

An electrochemical cell in which a container containing electrodes and an electrolyte is welded with a cap for sealing the container is known. The electrochemical cell has high sealing strength and high heat resistance because the container is welded to the cap by resistance welding. In the electrochemical cell using the welding seal rather than caulking seal, a mounting area can be effectively used, and excellent airtightness is exhibited, because the cell may take any optional shape unlike a conventional coin-type electrochemical cell.

### SUMMARY OF THE INVENTION

Much time and high cost have been required for examining presence of liquid leakage in the electrochemical cell.

Although the cap is welded to the container for sealing the container, when the welding is imperfect, leakage of electrolyte may occur, therefore a visual inspection of the electrochemical cell is necessary for finding presence of the liquid leakage.

However, in the conventional electrochemical cell, since the outer circumference of the cap was equal to that of the container, since the visual inspection for the liquid leakage from a side of the electrochemical cell was necessary, four sides had to be observed, resulting in high cost.

The invention intends to provide an electrochemical cell in which the inspection for the liquid leakage can be easily performed.

The invention is an electrochemical cell in which a container containing electrodes and an electrolyte is welded with a cap for sealing the container, wherein the outer circumference of the cap is made to be smaller than that of the container.

The electrochemical cell of the invention has a container containing a cathode, an anode, and an electrolyte, and a cap for sealing the container, wherein the container is bonded to the cap using a bonding material, and the outer circumference of the cap is made to be smaller than that of the container.

A method for manufacturing the electrochemical cell of the invention comprises a step of bonding a container containing electrodes and an electrolyte with a cap having the outer circumference smaller than that of the container, a step of heating the electrochemical cell comprising the container and the cap, a step of cooling the electrochemical cell, and a step of visually inspecting the electrochemical cell in a direction from an upside of the cap.

### ADVANTAGE OF THE INVENTION

In the conventional electrochemical cell in which the cap has the same size as the container, the inspection was necessary from four sides, and much time and high cost were required, however, in the electrochemical cell of the invention, the observation is necessary only from a top face of the electrochemical cell when it is inspected for liquid leakage.

Moreover, even in a configuration where a metal ring is provided between the container and the cap, it is possible that the observation of liquid leakage is necessary only in a direction from the upside of the cap, if the outer circumference of the container, metal ring and cap is made to be smaller in this order.

In the electrochemical cell of the invention, a surface for observing the liquid leakage is only a surface in a direction from the upside of the cap, thereby an imperfect bonding product can be easily determined, and the electrochemical cell can be provided at low cost.

### BRIEF DESCRIPTION OF THE DRAWINGS

FIG. 1 is a cross sectional view of an electrochemical cell of the invention;

FIG. 2 is a cross sectional view of an electrochemical cell of the invention;

FIG. 3 is a cross section view of a conventional electrochemical cell; and

FIG. 4 is a view showing an electrochemical cell in which liquid leakage occurred.

### DESCRIPTION OF THE PREFERRED EMBODIMENT

The electrochemical cell of the invention is a cell in which the outer circumference of the cap is smaller than that of the container.

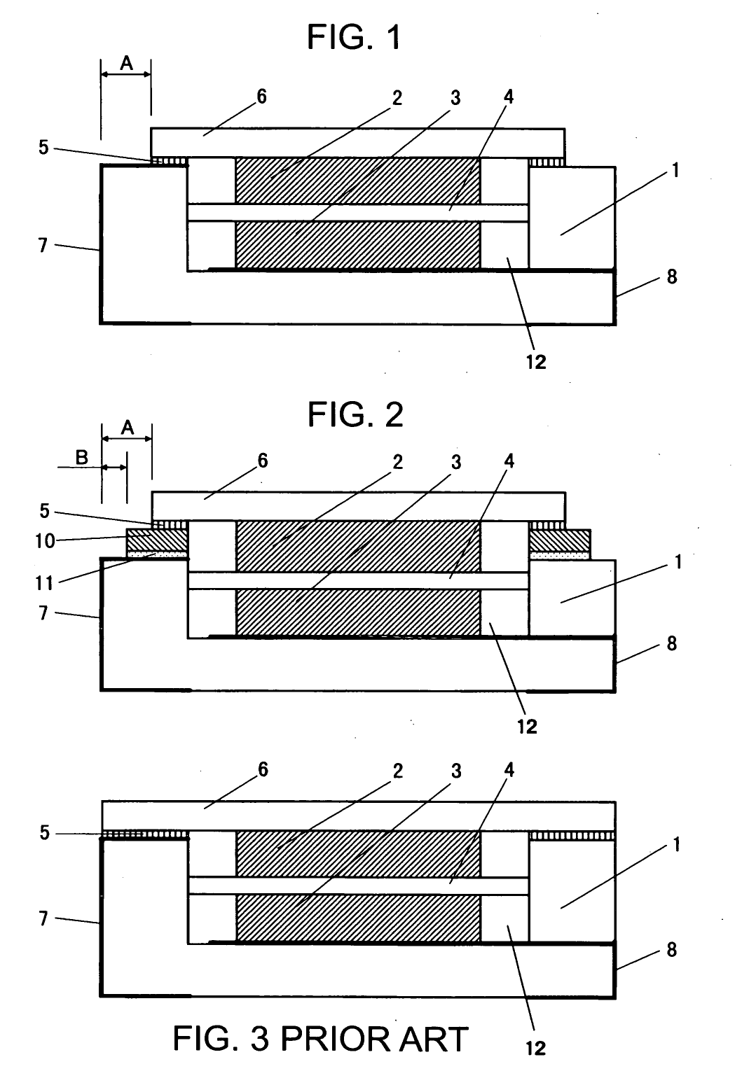

A typical structure of the invention is described using FIG. 1. A cathode 3 is isolated from an anode 2 using a separator 4 in a container 1, then an electrolyte 12 is infused, and then the container 1 is bonded to a cap 6 via a bonding material 5. The bonding material 5 may be previously applied at a container side, or a cap side, or on both the container and the cap by methods such as electroplating, pressure bonding, coating, printing, and evaporation. Alternatively, it may be previously molded in a manner corresponding to a bonding area and interposed between the container 1 and the cap 6. It may be applied partially on the cap 6, or entirely on one surface or both surfaces of the cap 6, and may be applied partially or entirely on a top face of the container 1.

Adhesion of the electrolyte or impurities on a bonding surface between the container 1 and the cap 6, displacement between the container 1 and the cap 6, or a void generated in the bonding material 5 causes imperfect bonding between the container 1 and the cap 6. The electrolyte 12 infused into the container 1 leaks out of the container through an imperfect bonding portion, causing reduction in capacity or increase in internal resistance of an electrochemical cell. In some cases, the electrolyte adheres to a circuit board mounted with the electrochemical cell, leading to corrosion in the board, which causes damage of the circuit board itself.

The cap 6 was made smaller than the container 1 only by a dimension A. The outer circumference of the cap 6 is made smaller than that of the container 1, whereby presence of liquid leakage can be found only by observing the electrochemical cell from a top face of the cell (direction from the cap 6). Since all the four sides need not be inspected, the inspection is finished in a short time and cost is lowered.

Moreover, as shown in FIG. 2, when a metal ring 10 is provided between the container 1 and the cap 6, heat is hard to be transferred to the container 1 at heating bonding, and crack or melt of the container 1 is prevented, resulting in improvement in airtightness. When a ring having the same thermal expansion coefficient as that of the container 1 or the cap 6 is used for the metal ring 10, crack is prevented, in addition, sealing performance is improved. The metal ring is made smaller than the container 1 only by a dimension B.

When such a metal ring 10 is provided, two bonding portions are given, and bonding materials are also necessary at two portions. The first is a bonding material 11 between the container 1 and the metal ring 10. The second is a bonding material 5 between the cap 6 and the metal ring 10. A material of the bonding material 11 may be equal to or different from that of the bonding material 5. Moreover, the bonding material 11 and the bonding material 5 may be previously applied on one or both of the container 1 and the metal ring 10, or one or both of the metal ring 10 and the cap 6 as above. Moreover, they may be previously applied partially or entirely on one surface or all surfaces of the container 1, metal ring 10, or cap 6. Moreover, the bonding material 11 may be interposed between the metal ring 10 and the container 1, and the bonding material 5 may be interposed between the cap 6 and the metal ring 10.

Even in the case that the metal ring is provided, since they are made such that the container 1 has the largest outer circumference and the cap has the smallest outer circumference, presence of liquid leakage can be found by visually inspecting the electrochemical cell from the top face of the cell. The metal ring 10 may be made to have the same diameter as the container 1.

FIG. 3 shows a cross sectional view of a conventional electrochemical cell. The electrolyte 12 leaks if the welding of cap 6 and container 1 is imperfect. However, in the conventional electrochemical cell, since the outer circumference of the cap was equal to that of the container, since the visual inspection for the liquid leakage from a side of the electrochemical cell was necessary, four sides had to be observed, resulting in high cost.

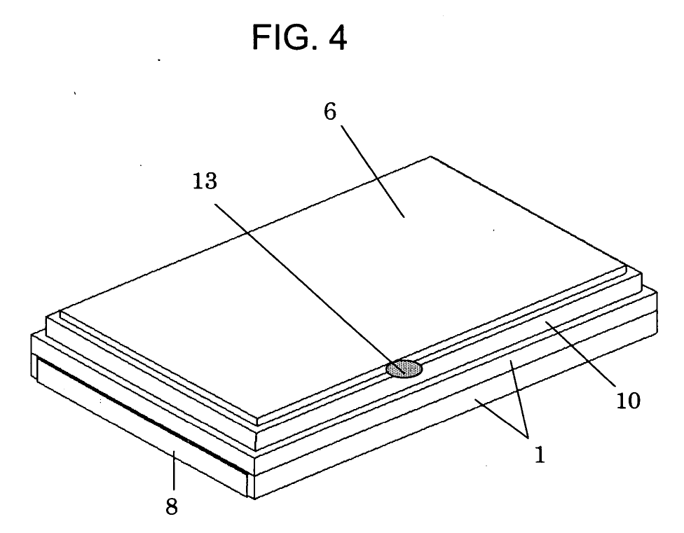

FIG. 4 is a perspective view of an electrochemical cell of the invention. Because the outer circumference of the cap 6 is smaller than that of the container 1, the presence of the liquid leakage 13 can be judged only from the observation from the upper surface of the electrochemical cell.

In the imperfect bonding product, the electrolyte infused into the container gradually leaks out with elapsed time by capillary action. The amount of leakage varies depending on size of a hole caused by the imperfect bonding, and if the size of the hole is large, large amount of electrolyte leaks, and if it is small, only slight amount of electrolyte leaks. Even if the amount is slight, an electrochemical cell in which leakage occurred has a problem of decrease in capacity. A cell having a large hole can be found in a short time using a microscope, however, a cell having a small hole can not be found in a short time.

A method for finding the imperfect bonding in a short time was found using liquid leakage due to increased pressure in the container caused by accelerated volatilization of the electrolyte by heating the cell after bonding the container to the cap.

An electrochemical cell is heated and then cooled, and then the bonding portion between the container and the cap is visually inspected, thereby presence of liquid leakage is found. In the method, the electrolyte leaks out even from a small hole in the bonding portion in a short time. Moreover, solvent in the leaked electrolyte evaporates with heat and only white supporting salt and a gel component are remained. Therefore, an area where the leakage occurred becomes large compared with an area of small hole as the imperfect bonding portion, therefore separation of the imperfect bonding product becomes easy, in addition, it can be performed in a short time. Heating temperature, which is different depending on a type of electrolyte to be used, is preferably approximately equal to a boiling point of the electrolyte.

### EXAMPLE 1

A nonaqueous-electrolyte secondary battery as shown in FIG. 1 was made. A box-type container 1 was formed by stacking two layers of ceramic sheets and a cathode terminal 8 was formed between them. An anode terminal 7 was formed along a side of the container from a bottom of the container 1 such that it electrically contacted to the bonding material 5. The container 1 was made to have a size of 5×3×0.9 mm, and the bonding material 5 comprising an AgCu alloy was formed on a top face of an outer wall of the container.

Commercially available molybdenum trioxide, graphite, and polyacrylic acid were mixed in a ratio of 50/45/5 in a percent by weight, and then formed into a molding by press at a pressure of 2 T/cm² and used as a cathode 3. An anode 2 was made by mixing commercially available silicon monoxide, graphite, and polyacrylic acid in a ratio of 45/40/15 in a percent by weight, and then forming into a molding by press at a pressure of 2 T/cm²₁ and then applying not-shown metal lithium on the molding.

Next, the cathode 3, a separator 4, and the anode 2 were put into the container 1 in this order, and then a liquid that 1 mol/l of LiBF₄ was dissolved in γ-BL/EC (1/1) was infused into the container 1 as an electrolyte 12. As a result, the silicon monoxide and the metal lithium were formed into a lithium-containing silicon oxide due to presence of the electrolyte.

As a cap 6, a cap in which FeNiCo alloy was used as base metal, and a bonding material 5 comprising AgCu alloy was applied on a portion to be bonded to the container was used. The cap was made to have a size of 4.8×2.8×0.1 mm, which was smaller than the outer circumference of the container 1. After that, the bonding material 5 was melted by resistance seam welding, and 1000 box-type nonaqueous-electrolyte secondary batteries were made and then cleaned using alcohol.

After the making, the cells were heated at 260° C. for 10 min, and then observed one by one using a microscope in only one direction from an upside of the cap 6. In 3 out of 1000 batteries, liquid leakage was found between the container 1 and the cap 6, which were determined to be defective.

### EXAMPLE 2

An electric double layer capacitor as shown in FIG. 2 was made. A box-type container 1 was formed by stacking two layers of ceramic sheets, and a cathode terminal 8 was formed between them. An anode terminal 7 was formed along a side of the container from a bottom of the container 1 such that it electrically contacted to the bonding material 11. The container 1 was made to have a size of 5×3×0.7 mm, and the bonding material 11 comprising an AgCu alloy was formed on a part of the container. After that, a metal ring 10, which comprises a FeNiCo alloy, having a peripheral size of 4.8×2.8×0.2 mm was placed on the bonding material 11 and then bonded to the material by heating. After that, Ni plating was applied on surfaces of the bonding material 11 and the metal ring 10, and then Au plating was applied thereon, which was used as a bonding material 5.

Commercially available activated carbon, graphite, and polytetrafluoroethylene were mixed in a ratio of 90/5/5 in a percent by weight, and then formed into a molding by press at a pressure of 2 T/cm² and used as a cathode 3. The same molding as for the cathode 3 was used for an anode 3.

Next, the cathode 3, a separator 4, and the anode 2 were put into the container 1 in this order, and then a liquid that 1 mol/l of (C₂H₅)₄NBF₄ was dissolved in propylene carbonate was infused into the container 1 as an electrolyte 12.

As a cap 6, a cap in which FeNiCo alloy was used as base metal and Ni plating 2 μm in thickness was applied thereon was used. The Ni plating was used as a bonding material 5. The cap 6 was made to have a size of 4.6×2.6×0.1 mm, which was smaller than the outer circumference of the metal ring 10.

The cap 6 was placed on the metal ring 10, and then the bonding material 5 was melted by resistance seam welding, and 1000 box-type electric-double-layer capacitors were made and then cleaned using alcohol. The electrochemical cells were heated at 260° C. for 10 min, and then cooled and observed using a microscope from an upside of the cap 6. In 2 out of 1000 cells, liquid leakage was found between the metal ring 10 and the cap 6, which were determined to be defective.

Next, examples of materials used for the electrochemical cell used in the invention are listed.

Positive active materials of the battery include lithium-containing cobalt oxide, lithium-containing nickel oxide, lithium-containing manganese oxide, lithium-containing titanium oxide, molybdenum trioxide, and niobium pentoxide. As negative active materials, traditionally known materials such as carbon, lithium-containing titanium oxide, niobium pentoxide, lithium-containing silicon oxide, and lithium-aluminum alloys can be used. To improve electric conductivity of the positive active materials and negative active materials, it is possible that an electric conduction assistant such as graphite and a binder such as vinylidene fluoride resin, polyvinyl alcohol, polytetrafluoroethylene, and polyacrylic acid are mixed to the active materials, and formed into a predetermined shape by press molding, thereby a cathode and an anode are formed.

Activated carbon is known as a cathode material and an active material of the electric double layer capacitor. For the electric conduction assistant and the binder, the same materials as for the battery can be used.

Materials for the electrolyte are not particularly limited, and the same materials as those used in conventional batteries or electric double layer capacitors can be used. For example, as the nonaqueous solvent, solvents such as propylene carbonate (PC), γ-butyrolacton (γBL), sulfolane (SL), ethylene carbonate (EC), dimethyl carbonate (DMC), diethyl carbonate (DEC), tetrahydrofuran (THF), 1,2-dimethoxyethane (DME), and acetonitrile (AN) can be used singly or in a mixed manner. As the supporting salt, one or more of salts such as lithium salts including (C₂H₅)₄PBF₄, (C₃H₇)₄PBF₄, (CH₃) (C₂H₅)₃NBF₄, (C₂H₅)₄NBF₄, (C₂H₅)₄PPF₆, (C₂H₅)₄PCF₃SO₄, (C₂H₅)₄NPF₆, lithium perchlorate (LiClO₄), lithium phosphate hexafluoride (LiPF₆), lithium boride fluoride (LiBF₄), lithium arsenide hexafluoride (LiAsF₆), lithium trifluorometasulfonate (LiCF₃SO₃), lithium bis(trifluoromethylsulfonyl)imide [LiN(CF₃SO₂)₂], thiocyanate, and aluminum fluoride can be used. A predetermined amount of supporting salt is dissolved in the nonaqueous solvent, and the resultant liquid can be used as the electrolyte.

An electrolyte which was formed to be gel by using a polyethylene oxide derivative or a polymer containing the derivative, a phosphoric ester polymer, or PVDF with the nonaqueous solvent and the supporting salt can be also used. When the bonding is performed after the electrolyte is infused into the container, in the electrolyte which was formed to be gel, rising of the electrolyte to the bonding surface by capillary action does not occur, and bond with excellent airtightness can be obtained.

Conventionally known materials such as ceramic, glass, thermosetting resin such as epoxy resin, or thermoplastic resin such as PPS, PEEK and LCP can be used for the container. Particularly, since the electrochemical cell using the nonaqueous solvent is adversely affected by water, a container material having small water permeability needs to be used, therefore a container using ceramic is preferable compared with a container using resin.

Materials of the cap include ceramic, glass, thermosetting resin such as epoxy resin, thermoplastic resin such as PPS, PEEK and LCP, or metal such as FeNi alloy and FeNiCo alloy. A FeNiCo alloy applied with Ni plating as the bonding material is used for the cap, and the entire circumference of the cap is subjected to seam welding. Bonding is performed between the Ni/Au plating at a metal ring side and the Ni plating at a cap side. In the method, the bonding material can be applied on the cap with inexpensive plating. Since the resistance seam welding can be completed in several seconds when a package is small, volatilization of the electrolyte infused into the container can be minimized, which is preferable.

The bonding materials include adhesives containing epoxy resin, acrylic resin, or silicone resin as a main component, AgCu alloys, AuCu alloys, AuSn alloys, and brazing filler metals such as Ni, Au, and AuNi.

A bonding method using the adhesives includes a method of thermosetting type where a curing agent is added to the adhesive as a main component, a method of ultraviolet curing type, and a method of water volatilization curing type. In a bonding method using the brazing filler metals, the metals are heated to a melting point of each metal or more and then cooled, whereby the brazing filler metals are cured for bonding. For example, in FIG. 2, ceramic is used for the container 1, a FeNiCo alloy having a thermal coefficient similar to that of the ceramic is used for the metal ring 10, and an AgCu alloy is used for the bonding material 11; and they are bonded by heating; and then Ni plating is applied on a surface of the metal ring 10, and then Au plating is applied thereon. The plating enables simultaneous formation of the anode terminal 7 on a bottom of the container 1, exhibits excellent soldering performance to a board for mounting, and can be formed to be the bonding material 5.

According to the manufacturing method of the invention, a surface for observing the liquid leakage is made to be only one surface, thereby an imperfect bonding product can be easily separated, and a reliable electrochemical cell can be provided at low cost.

What is claimed is:

1. An electrochemical cell comprising a container containing a cathode, an anode, and an electrolyte, and a cap for sealing the container; wherein the container is bonded to the cap using a bonding material, and outer circumference of the cap is made to be smaller than that of the container.

2. The electrochemical cell according to claim 1, wherein a metal ring is provided between the container and the cap, the container is bonded to the metal ring using a bonding material, the metal ring is bonded to the cap using a bonding material, the outer circumference of the cap is made to be smaller than that of the metal ring, and the outer circumference of the metal ring is made to be smaller than or equal to that of the container.

3. The electrochemical cell according to claim 1, wherein the container comprises ceramic.

4. The electrochemical cell according to claim 1, wherein the electrolyte is liquid or gel.

5. An electrochemical cell comprising a container and a cap, wherein outer circumference of the cap is smaller than that of the container.

6. The electrochemical cell according to claim 5, wherein the container has a metal ring, and the container is bonded to the cap via the metal ring.

7. The electrochemical cell according to claim 1, wherein the container and the cap are sealed by resistance welding.

8. A method for manufacturing an electrochemical cell comprising a step of bonding a container containing electrodes and an electrolyte with a cap having smaller outer-circumference than that of the container, a step of heating an electrochemical cell comprising the container and the cap, a step of cooling the electrochemical cell, and a step of visually inspecting the electrochemical cell in a direction from an upside of the cap.

9. The method for manufacturing the electrochemical cell according to claim 8, wherein the container has a metal ring, and the container is bonded to the cap via the metal ring.
